(19) United States
(12) Patent Application Publication
(10) Pub. No.: US 2016/0214873 A1
(43) Pub. Date: Jul. 28, 2016

(54) ULTRAVIOLET IRRADIATION DEVICE

(71) Applicant: KABUSHIKI KAISHA TOSHIBA, Tokyo (JP)

(72) Inventors: Norimitsu Abe, Kawasaki (JP); Shinji Kobayashi, Tokyo (JP); Takeshi Ide, Tokyo (JP); Akihiko Shirota, Tokyo (JP); Kenji Takeuchi, Tokyo (JP)

(21) Appl. No.: 14/917,936

(22) PCT Filed: Mar. 12, 2014
(86) PCT No.: PCT/JP2014/056569

§ 371 Date: Mar. 9, 2016

(30) Foreign Application Priority Data
Sep. 12, 2013 (JP) 2013-189252

(51) Int. Cl. C02F 1/32

(52) U.S. Cl. CPC C02F 1/325; C02F 2201/3225; C02F 2301/026; C02F 2201/3227; C02F 2303/04

(57) ABSTRACT

According to an embodiment, an ultraviolet irradiation device includes a barrel, an inflow pipe, an outflow pipe. An ultraviolet irradiation tube is placed through the barrel. The ultraviolet irradiation tube irradiates an inflow of water to be treated with ultraviolet light. The water to be treated flows into the barrel through the inflow pipe. The water to be treated flows out of the barrel through the outflow pipe. The inflow pipe and the outflow pipe are arranged to allow the water to be treated to form into a swirl flowing along an inner wall of the barrel.

### FIELD

Embodiments of the present invention relate to an ultraviolet irradiation device.

### BACKGROUND

Ozone and chemicals such as chlorine are conventionally used to disinfect and sterilize treated water (such as tap water or groundwater) in water supply and sewage, deodorize and decolor industrial water or bleach pulp, as well as to disinfect medical equipment. A conventional sterilizing apparatus requires a retention tank and an agitator such as a spray pump to uniformly dissolve ozone or chemicals in the treated water, therefore, it cannot promptly deal with a sudden change in quality or volume of water.

On the other hand, ultraviolet light exerts disinfection, sterilization, and decoloring, deodorization and decoloring of industrial water or bleach of pulp. Further, an ultraviolet lamp can quickly deal with a sudden change in the quality or volume of water by adjusting its output.

As a technique using such an ultraviolet lamp, there is a structure (refer to Patent Literature 1) including a cylindrical water passage barrel and a lamp housing having a circular tube with a diameter smaller than that of the passing water barrel, in which the barrel is joined crisscross to the lamp housing and a plurality of ultraviolet irradiation tubes made of quartz glass and accommodating ultraviolet lamps is installed in the lamp housing in parallel to the axis of the lamp housing. An ultraviolet irradiation device having the aforementioned configuration is suitable for a relatively large-scale treatment system because it has a large water pipe diameter and the number of lamp housings to be installed can be increased or decreased as appropriate to cope with a variation in the amount of ultraviolet light required.

### CITATION LIST

### Patent Literature

Patent Literature 1: U.S. Pat. No. 7,045,102

Patent Literature 2: U.S. Pat. No. 7,385,204

Patent Literature 3: U.S. Pat. No. 6,976,508

### SUMMARY OF THE INVENTION

### Problem to be Solved by the Invention

Conventionally, however, it is difficult to match the pipe diameter determined according to treatment capacity with the length of the ultraviolet lamp selected according to the amount of irradiation required, for the following reasons (1) to (4).

(1) The length of the ultraviolet lamp increases as the output thereof increases.

(2) Amount of ultraviolet light required for treatment differs since materials to be treated are diverse and differ in density.

(3) Ultraviolet irradiation efficiency varies depending on ultraviolet transmittance (UVT) of raw water.

(4) The pipe diameter adopted in a treatment facility differs depending on its planned treatment capacity.

For the aforementioned reasons, it is difficult to match the pipe diameter determined according to the treatment capacity with the length of the ultraviolet lamp selected according to the amount of irradiation required. Particularly, when a large amount of irradiation (such as several ten to several hundred times that applied in water purification) is needed because of a low UVT or advanced oxidation from hydrogen peroxide and ultraviolet light or ozone and ultraviolet light in sewage treatment, an irradiation device identical to that for water purification needs to reduce a treatment flow rate to one tenth or less. In such a water treatment plant having a small connecting pipe diameter, a flow passage is uneven and not uniformly irradiated with ultraviolet light from a high-output lamp with a long luminous length, resulting in lowering irradiation efficiency.

In view of the above, an object of the present invention is to provide an ultraviolet irradiation device which can irradiate water to be treated with all of ultraviolet light emitted from an ultraviolet lamp without excess or deficiency and perform sufficient ultraviolet water treatment even with a change in the type or volume of water.

### Means for Solving Problem

An ultraviolet irradiation device of embodiment comprises: a barrel portion in which an ultraviolet irradiation tube is placed, the ultraviolet irradiation tube irradiating an inflow of water to be treated with ultraviolet light; an inflow pipe through which the water to be treated flows into the barrel portion; and an outflow pipe through which the water to be treated flows out of the barrel portion, wherein the inflow pipe and the outflow pipe are arranged to allow the water to be treated to form into a swirl flowing along an inner wall of the barrel portion.

### BRIEF DESCRIPTION OF DRAWINGS

FIG. 1 is an external view of an ultraviolet irradiation device (ultraviolet irradiation unit) according to a first embodiment.

FIG. 2 is a cross sectional view of FIG. 1 along the line indicated by the arrows A-A.

FIG. 3 is a schematic illustrative diagram of an ultraviolet irradiation tube.

FIG. 4 is an external view of an ultraviolet irradiation device (ultraviolet irradiation unit) according to a second embodiment.

FIG. 5 is a cross sectional view of FIG. 4 along the line indicated by the arrows A-A.

FIG. 6 is an external view of an ultraviolet irradiation device (ultraviolet irradiation unit) according to a third embodiment.

FIG. 7 is an external view of an ultraviolet irradiation device (ultraviolet irradiation unit) according to a fourth embodiment.

FIG. 8 is a cross sectional view of FIG. 7 along the line indicated by the arrows A-A.

FIG. 9 is an external view of an ultraviolet irradiation device (ultraviolet irradiation unit) according to a fifth embodiment.

FIG. 10 is a cross sectional view of FIG. 9 along the line indicated by the arrows A-A.

FIG. 11 is an external view of an ultraviolet irradiation device (ultraviolet irradiation unit) according to a sixth embodiment.

FIG. 12 is a cross sectional view of FIG. 11 along the line indicated by the arrows A-A.

### DETAILED DESCRIPTION

Embodiments will now be described with reference to the drawings.

### [1] First Embodiment

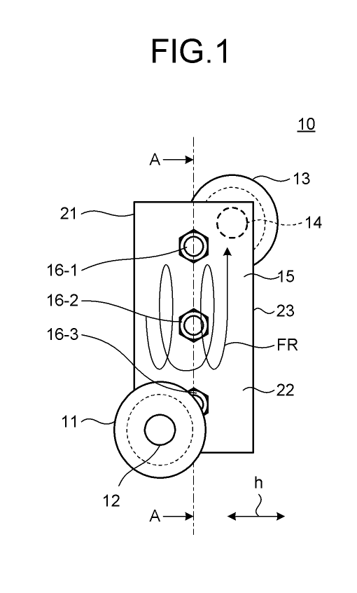

FIG. 1 is an external view of an ultraviolet irradiation device (ultraviolet irradiation unit) according to a first embodiment.

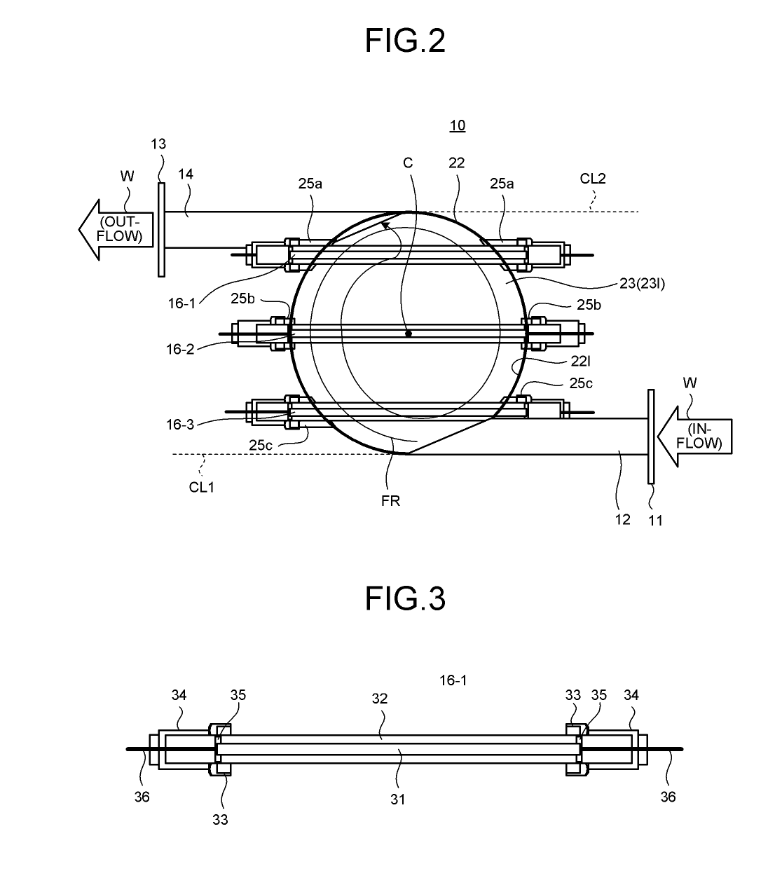

FIG. 2 is a cross sectional view of FIG. 1 along the line indicated by the arrows A-A.

An ultraviolet irradiation device 10 includes an inflow pipe 12 having a first flange joint 11 connected to a flange joint of an existing pipe, an outflow pipe 14 having a second flange joint 13 connected to a flange joint of an existing pipe, an annular barrel 15 having a columnar (cylindrical) outer shape, and a plurality of (three in FIG. 1) ultraviolet irradiation tubes 16-1 to 16-3 inserted in the annular barrel 15.

While according to the present embodiment the three ultraviolet irradiation tubes 16-1 to 16-3 are provided, one, two, or four or more ultraviolet irradiation tubes may be provided depending on the amount of ultraviolet light required.

The annular barrel 15 includes a disk-shaped first top plate 21, a cylindrical barrel body 22, and a disk-shaped second top plate 23.

Moreover, the annular barrel 15 has a total of six through holes, two through holes for each of the ultraviolet irradiation tubes 16-1 to 16-3. Bushings 25a, 25b, and 25c are inserted through the six through holes and fixed therein.

The barrel body 22 includes the inflow pipe 12 extending along a tangent line CL1 to the second top plate 23 (or the first top plate 21, the same applies hereinafter) when regarded as a circle in a planar view as illustrated in FIG. 2. An inner wall 231 of the second top plate 23 is illustrated in FIG. 2.

Moreover, the outflow pipe 14 is provided in parallel to the extension of the inflow pipe 12, namely along a tangent line CL2 parallel to the tangent line CL1, at a position point-symmetric with a position of the inflow pipe 12 relative to a center point C of the first top plate 21, when the second top plate 23 is regarded as a circle.

The inflow pipe 12 and the outflow pipe 14 are provided at different positions along the height (h-direction) of the annular barrel 15 (barrel body 22) as illustrated in FIG. 1. More specifically, the inflow pipe 12 is provided closer to the first top plate 21 while the outflow pipe 14 is provided closer to the second top plate 23.

Now, the ultraviolet irradiation tubes 16-1 to 16-3 will be described.

FIG. 3 is a schematic illustrative diagram of the ultraviolet irradiation tube.

Since the ultraviolet irradiation tubes 16-1 to 16-3 have the identical configuration, the ultraviolet irradiation tube 16-1 will be described as an example.

The ultraviolet irradiation tube 16-1 includes an ultraviolet lamp 31 and a quartz glass tube 32.

The ultraviolet lamp 31 is a lamp that irradiates water to be treated W flowing through the annular barrel 15 with ultraviolet light.

The ultraviolet lamp 31 of the present embodiment includes a light-emitting portion that emits ultraviolet light and has a length (luminous length) within the range of −10% to +10% of an inner diameter of the annular barrel 15. Moreover, the ultraviolet lamp 31 emits ultraviolet light with wavelengths of 200 nm to 300 nm.

The quartz glass tube 32 is a protective tube made of quartz glass and houses the ultraviolet lamp 31.

The ultraviolet irradiation tube 16-1 further includes O-ring holders 33, caps 34 and positioning pieces 35 in addition to the ultraviolet lamp 31 and the quartz glass tube 32.

A power supply wiring 36 is connected to both ends of the ultraviolet irradiation tube 16-1 as illustrated in FIG. 3.

The O-ring holders 33 are adapted to hold O-rings. The positioning pieces 35 are attached to both ends of the ultraviolet lamp 31 and hold the ultraviolet lamp 31 in the center of the quartz glass tube 32.

The caps 34 are attached to both ends of the quartz glass tube 32 to protect both ends of the quartz glass tube 32 and prevent leakage of the ultraviolet light irradiated from the ultraviolet lamp 31 to the outside. The caps 34 each include a conductor hole through which the power supply wiring 36 for the ultraviolet lamp 31 inserts.

The ultraviolet irradiation tubes 16-1 to 16-3 are provided in parallel to one another on a plane intersecting the height (h-direction) of the annular barrel 15 (barrel body 22) (or a plane including a direction intersecting the h-direction). Specifically, the three ultraviolet irradiation tubes 16-1 to 16-3 are arranged in parallel to one another on a plane orthogonal to (an example of intersecting) the h-direction. That is, the ultraviolet irradiation tubes 16-1 to 16-3 are arranged in a row vertically along the sectional line A-A as illustrated in FIG. 1.

The ultraviolet irradiation tubes 16-1 to 16-3 are mounted in the annular barrel 15 with both ends thereof inserting into the bushings 25a, 25b and 25c fixed to the six through holes of the annular barrel 15.

Moreover, not-illustrated triangular grooves for the O-rings are formed at or near outer ends of the bushings 25a, 25b and 25c to place the O-rings in the triangular grooves and secure them with the O-ring holders 33 (refer to FIG. 3). Thereby, the ultraviolet irradiation tubes 16-1 to 16-3 are water-tightly fixed to the annular barrel 15.

Next, there will be described an overview of an ultraviolet light irradiation of the ultraviolet irradiation device 10 of the first embodiment.

With the aforementioned configuration, flowing into the inflow pipe 12, the water to be treated W does not form into a direct short-circuit flow to the outflow pipe 14 but flows in a swirl FR (refer to FIGS. 1 and 2) along an inner wall 221 of the barrel body 22.

The swirl FR of the water to be treated W having flowed through the inflow pipe 12 eventually becomes a spiral and flows along the inner wall 221 of the barrel body 22 toward the outflow pipe 14.

Thus, the formed swirl (spiral) FR of the water to be treated W repeatedly flows around the ultraviolet lamp 31 (ultraviolet irradiation tubes 16-1 to 16-3) from the inflow pipe 12 toward the outflow pipe 14, increasing an effective passage length and an effective irradiation amount of ultraviolet light per unit volume of the water to be treated W.

That is, according to the present embodiment, by flowing through the inflow pipe 12 connected to the annular barrel 15 along the tangent line CL1, the water to be treated W forms into the swirl FR and flows inside the annular barrel 15.

As a result, the water to be treated W is uniformly irradiated with the ultraviolet light output (emitted) from the ultraviolet lamp 31. The ultraviolet light can thus contribute to the sterilizing (disinfecting) treatment or oxidation treatment of target substances such as microorganisms, organic matter and inorganic matter contained in the water to be treated W and can improve irradiation efficiency (disinfection efficiency, sterilization efficiency, oxidation efficiency and the like).

### [2] Second Embodiment

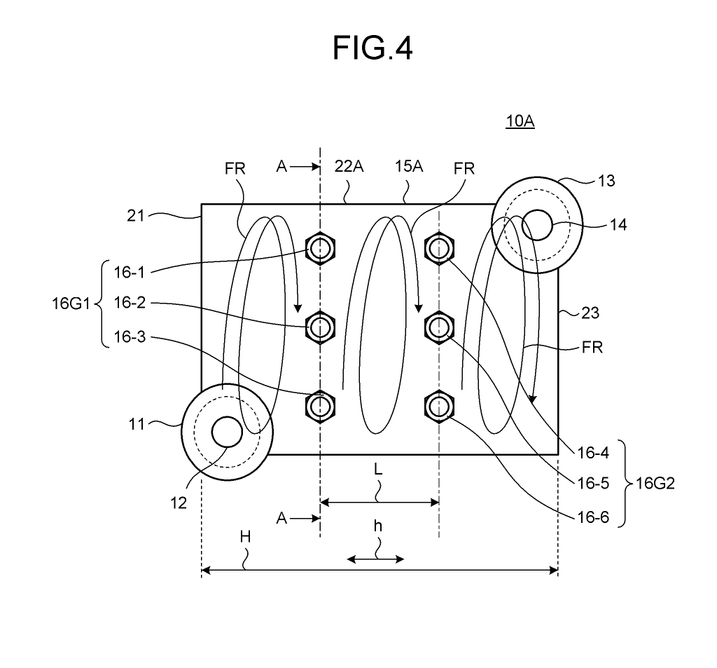

FIG. 4 is an external view of an ultraviolet irradiation device (ultraviolet irradiation unit) according to a second embodiment.

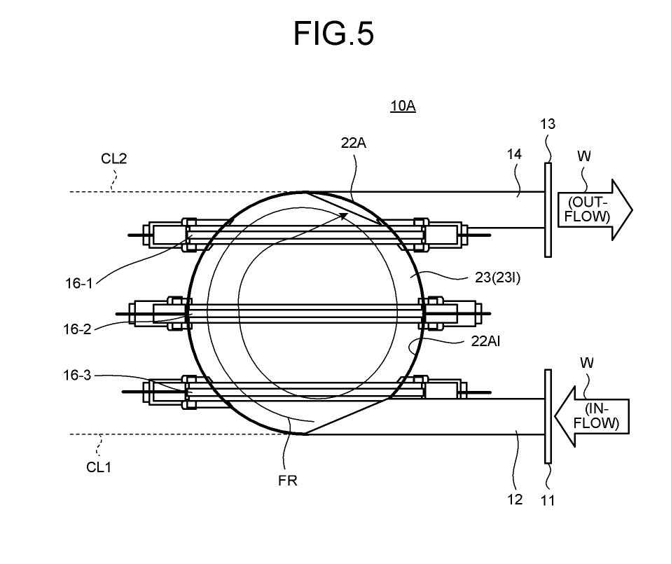

FIG. 5 is a cross sectional view of FIG. 4 along the line indicated by the arrows A-A.

An ultraviolet irradiation device 10A of the second embodiment is different from the ultraviolet irradiation device 10 of the first embodiment in that an annular barrel is taller (longer) in height (in an h-direction), a plurality (two sets in FIG. 4) of ultraviolet irradiation tube groups is arranged in parallel to one another at a certain distance away from one another, and an inflow pipe and an outflow pipe are provided on the same side of the annular barrel to reverse the directions of an inflow and an outflow of water to be treated. The ultraviolet irradiation tube group are a plurality of ultraviolet irradiation tubes provided in parallel to one another on a plane intersecting the height (h-direction) of the annular barrel (or a plane including a direction intersecting the h-direction).

The ultraviolet irradiation device 10A includes an inflow pipe 12 having a first flange joint 11 connected to a flange joint of an existing pipe, an outflow pipe 14 having a second flange joint 13 connected to a flange joint of an existing pipe, an annular barrel 15A having a columnar shape, and a plurality of (six in FIG. 4) ultraviolet irradiation tubes 16-1 to 16-6 inserted in the annular barrel 15A.

The annular barrel 15A includes a disk-shaped first top plate 21, a cylindrical barrel body 22A, and a circular second top plate 23.

The ultraviolet irradiation tubes 16-1 to 16-3 form an ultraviolet irradiation tube group 16G1 while the ultraviolet irradiation tubes 16-4 to 16-6 form an ultraviolet irradiation tube group 16G2.

In place of the two ultraviolet irradiation tube groups 16G in the present embodiment, three or more sets can be provided as well. In such case, the number of ultraviolet irradiation tubes of the ultraviolet irradiation tube groups 16G may be one (also referred to as ultraviolet irradiation tube group for the sake of convenience), two, or four or more depending on the amount of ultraviolet light required.

In this case the ultraviolet irradiation tubes of each ultraviolet irradiation tube group 16G are provided in parallel to one another on a plane intersecting the height (h-direction) of the annular barrel 15A (barrel body 22A) (or a plane including a direction intersecting the h-direction). Specifically, the three ultraviolet irradiation tubes 16-1 to 16-3 are arranged in parallel to one another on a plane orthogonal to the h-direction.

The ultraviolet irradiation tube groups 16G are arranged at a certain distance L away from each other. The certain distance L is set to a distance to be able to approximately equally divide the space in the annular barrel 15A (barrel body 22A). For example, in FIG. 4 the two ultraviolet irradiation tube groups 16G1 and 16G2 are placed with a distance (L≈H/3) to approximately equally divide the space in the annular barrel 15A (barrel body 22A) into three.

The barrel body 22A includes the inflow pipe 12 extending along a tangent line CL1 to the second top plate 23 (or the first top plate 21; the same applies hereinafter) when regarded as a circle in a planar view as illustrated in FIG. 5. An inner wall 231 of the second top plate 23 is illustrated in FIG. 5.

Moreover, as illustrated in FIG. 5, the outflow pipe 14 is provided at a position along a tangent line CL2 parallel to the tangent line CL1 plane-symmetrically with a position of the inflow pipe 12 relative to a plane including the axis of the ultraviolet irradiation tube 16-2 and perpendicular to the front face of FIG. 5, when the second top plate 23 is regarded as a circle in a planar view.

The inflow pipe 12 and the outflow pipe 14 are provided at different positions along the height (h-direction) of the annular barrel 15A (barrel body 22A) as illustrated in FIG. 4. More specifically, the inflow pipe 12 is provided closer to the first top plate 21 while the outflow pipe 14 is provided closer to the second top plate 23.

Next, there will be described an overview of ultraviolet light irradiation of the ultraviolet irradiation device 10A of the second embodiment.

With the aforementioned configuration, flowing into the inflow pipe 12, water to be treated W does not form into a direct short-circuit flow from the inflow pipe 12 to the outflow pipe 14 but forms into a swirl FR (refer to FIGS. 4 and 5) flowing along an inner wall 22AI of the barrel body 22A and reaches the vicinity of the ultraviolet irradiation tube group 16G1. The swirl FR of water repeatedly flows around the ultraviolet irradiation tubes 16-1 to 16-3, and then reaches the vicinity of the ultraviolet irradiation tube group 16G2. Then, the swirl FR of water repeatedly flows around the ultraviolet irradiation tubes 16-4 to 16-6.

The swirls FR of the water to be treated W having flowed into the inflow pipe 12 eventually becomes a spiral and flows along the inner wall 22AI of the barrel body 22A toward the outflow pipe 14.

Since the outflow pipe 14 is provided at a position along the tangent line CL2 parallel to the tangent line CL1 plane-symmetrically with the position of the inflow pipe 12 relative to the plane including the axis of the ultraviolet irradiation tube 16-2 and perpendicular to the front face of FIG. 5 when the second top plate 23 is regarded as a circle in a planar view the swirl FR (spiral) of water does not become turbulent while flowing out through the outflow pipe 14.

According to the second embodiment as well, as described above, the swirl (spiral) FR of the water to be treated W repeatedly flows around the ultraviolet irradiation tube groups 16G1 and 16G2 from the inflow pipe 12 toward the outflow pipe 14, increasing an effective passage length and an effective irradiation amount of ultraviolet light per unit volume of the water to be treated W.

That is, as in the first embodiment, the water to be treated W according to the second embodiment flows into the inflow pipe 12 connected to the annular barrel 15 along the tangent line CL1 and forms into the swirl FR inside the annular barrel 15A and is uniformly irradiated with the ultraviolet light output (emitted) from an ultraviolet lamp 31. Thus, the ultraviolet light can contribute to the sterilizing (disinfecting) treatment or oxidation treatment of target substances such as microorganisms, organic matter and inorganic matter contained in the water to be treated W and can improve irradiation efficiency (disinfection efficiency, sterilization efficiency, oxidation efficiency and the like).

Moreover, according to the second embodiment, the swirl FR (spiral) of water flows out from the outflow pipe 14 without turbulence, which can reduce passage resistance and further enhance treatment efficiency.

### [3] Third Embodiment

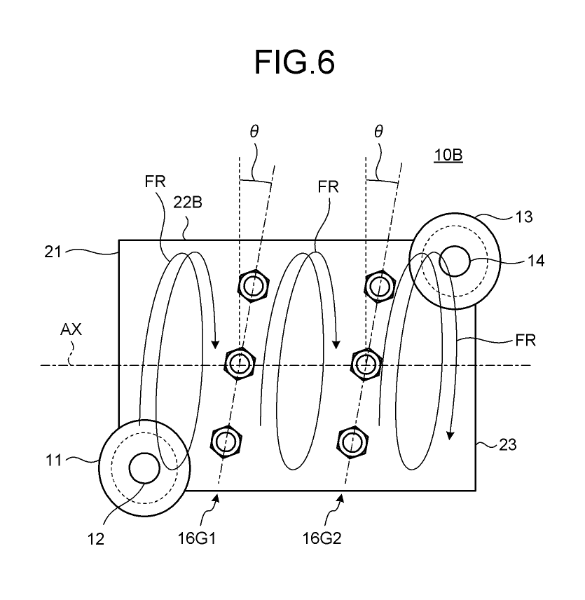

FIG. 6 is an external view of an ultraviolet irradiation device (ultraviolet irradiation unit) according to a third embodiment.

An ultraviolet irradiation device 10B of the third embodiment is different from the ultraviolet irradiation device 10A of the second embodiment in that ultraviolet irradiation tubes 16-1 to 16-3 of an ultraviolet irradiation tube group 16G1 and ultraviolet irradiation tubes 16-4 to 16-6 of an ultraviolet irradiation tube group 16G2 are arranged on a plane tilted by a certain angle θ with respect to a plane perpendicular to a central axis AX of an annular barrel 22B.

According to the third embodiment, the swirl FR (spiral) can flow closer to the arranged ultraviolet irradiation tubes 16-1 to 16-3 and 16-4 to 16-6 of the ultraviolet irradiation tube groups 16G1 and 16G2. Because of this the water to be treated W can stay longer near the ultraviolet irradiation tube group 16G1 or the ultraviolet irradiation tube group 16G2 and be continuously irradiated with ultraviolet light at certain intensity or higher, which can further improve treatment efficiency.

### [4] Fourth Embodiment

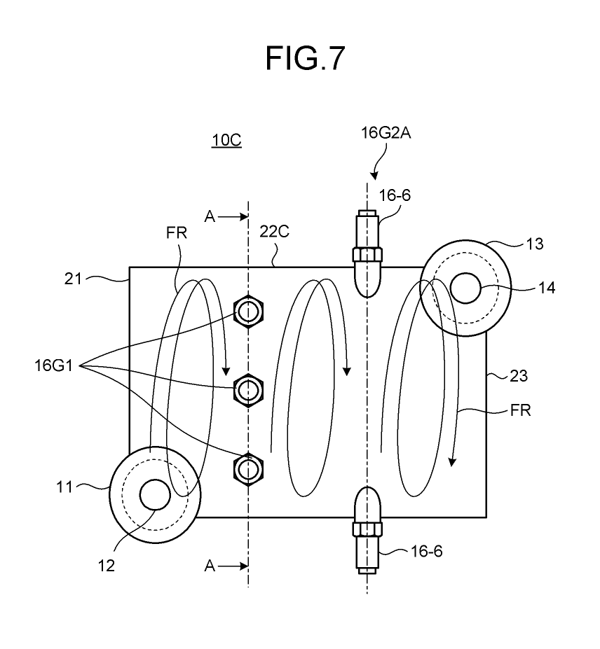

FIG. 7 is an external view of an ultraviolet irradiation device (ultraviolet irradiation unit) according to a fourth embodiment.

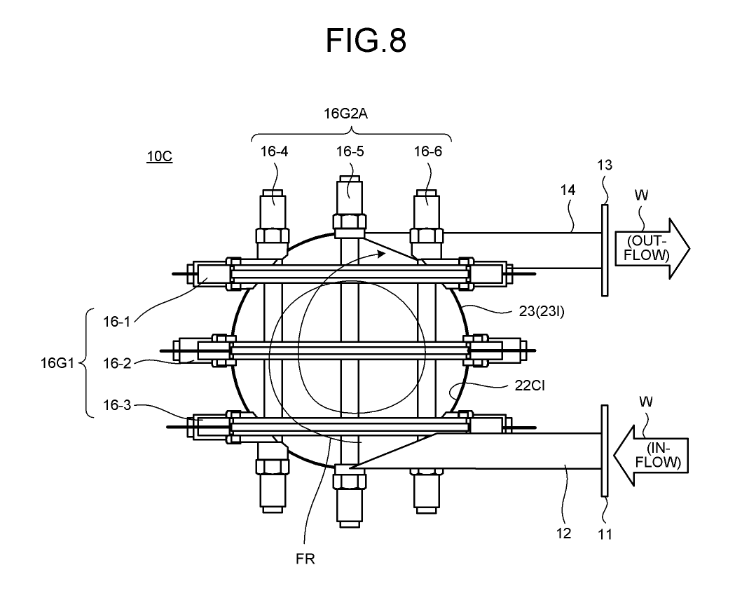

FIG. 8 is a cross sectional view of FIG. 7 along the line indicated by the arrows A-A.

An ultraviolet irradiation device 10C of the fourth embodiment is different from the ultraviolet irradiation device 10A of the second embodiment in that ultraviolet irradiation tubes 16-1 to 16-3 of a first ultraviolet irradiation tube group 16G1 are configured to extend in a direction orthogonal to (turned 90 degrees from) the extension of ultraviolet irradiation tubes 16-4 to 16-6 of a second ultraviolet irradiation tube group 16G2A.

According to the fourth embodiment, the aforementioned configuration can decrease the occurrence of a short-circuit flow of water to be treated W in a direction perpendicular to the front face of FIG. 5 in the second embodiment, and allow the water to be treated W to stay longer near the ultraviolet irradiation tube group 16G1 or the ultraviolet irradiation tube group 16G2A and be continuously irradiated with ultraviolet light at certain intensity or higher, which can further improve treatment efficiency.

### [5] Fifth Embodiment

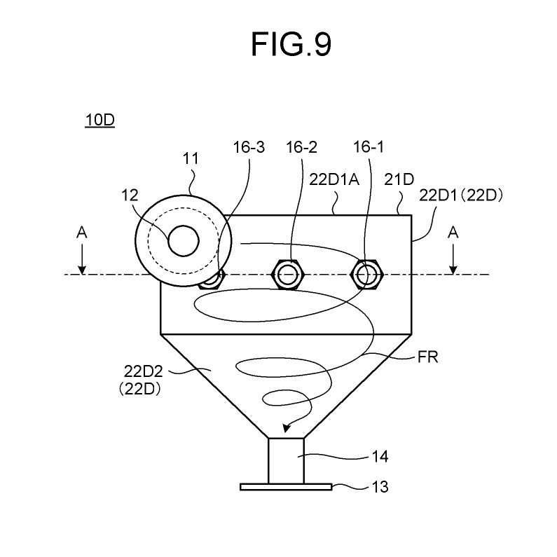

FIG. 9 is an external view of an ultraviolet irradiation device (ultraviolet irradiation unit) according to a fifth embodiment.

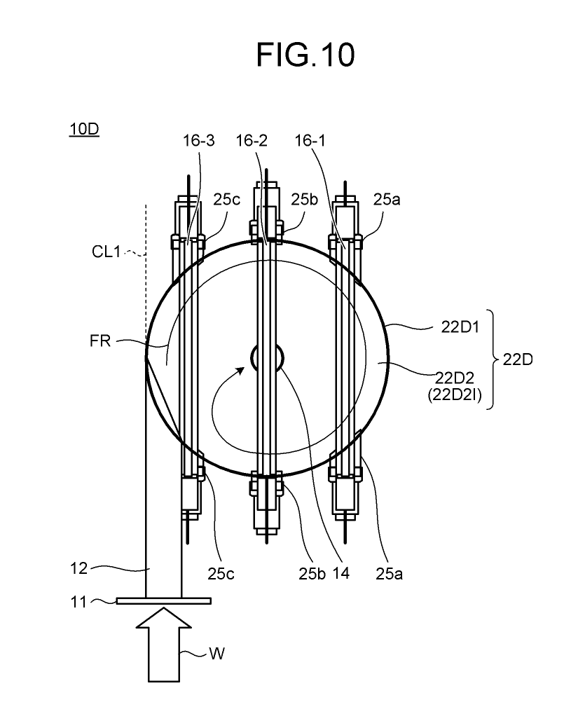

FIG. 10 is a cross sectional view of FIG. 9 along the line indicated by the arrows A-A.

In FIGS. 9 and 10, like or same elements to those in FIGS. 1 and 2 are assigned the like or same reference numerals as those in FIGS. 1 and 2.

An ultraviolet irradiation device 10D of the fifth embodiment includes an inflow pipe 12 having a first flange joint 11 connected to a flange joint of an existing pipe, an outflow pipe 14 having a second flange joint 13 connected to a flange joint of an existing pipe, a barrel 22D including a columnar (cylindrical) annular barrel 22D1 and a truncated-cone (funnel) barrel 22D2 having a truncated cone shape, and a plurality of (three in FIG. 9) ultraviolet irradiation tubes 16-1 to 16-3 inserted in the annular barrel 22D1.

According to the fifth embodiment, the three ultraviolet irradiation tubes 16-1 to 16-3 are provided, however, one, two, or four or more ultraviolet irradiation tubes may be provided depending on the amount of ultraviolet light required.

The annular barrel 22D1 includes a disk-shaped top plate 21D and a cylindrical barrel body 22D1A.

Moreover, the barrel body 22D1A has a total of six through holes, two through holes for each of the ultraviolet irradiation tubes 16-1 to 16-3. Bushings 25a, 25b, and 25c are inserted and fixed into the six through holes.

The barrel body 22D1A includes an inflow pipe 12 extending along a tangent line CL1 to the top plate 21D when regarded as a circle as illustrated in FIG. 10. An inner surface 22D2I of the truncated-cone barrel 22D2 is illustrated in FIG. 10.

The truncated-cone barrel 22D2 further includes, at the bottom end, an outflow pipe 14 extending downward.

Next, there will be described an overview of an ultraviolet light irradiation of the ultraviolet irradiation device 10D of the fifth embodiment.

Water to be treated W flows into the inflow pipe 12 and forms into a swirl FR flowing inside the annular barrel 22D1 along a peripheral surface thereof.

Upon reaching the truncated-cone barrel 22D2, the swirl FR flows toward the outflow pipe 14 while gradually decreasing in the swirl diameter.

The formed swirl (spiral) FR of the water to be treated W repeatedly flows around the ultraviolet irradiation tubes 16-1 to 16-3 from the inflow pipe 12 toward the outflow pipe 14, increasing an effective passage length and an effective irradiation amount of ultraviolet light per unit volume of the water to be treated W.

That is, in the fifth embodiment as well, the water to be treated W forms into the swirl FR, flows from the inflow pipe 12 toward the outflow pipe 14, and is uniformly irradiated with ultraviolet light output (emitted) from an ultraviolet lamp 31. The ultraviolet light can thus contribute to the sterilizing (disinfecting) treatment or oxidation treatment of target substances such as microorganisms, organic matter and inorganic matter contained in the water to be treated W and can increase irradiation efficiency (disinfection efficiency, sterilization efficiency, oxidation efficiency and the like).

### [6] Sixth Embodiment

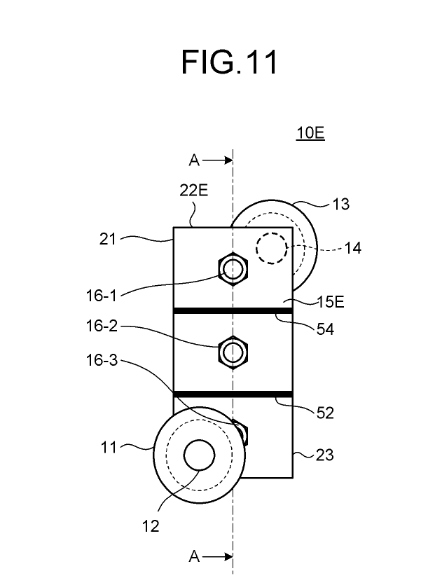

FIG. 11 is an external view of an ultraviolet irradiation device (ultraviolet irradiation unit) according to a sixth embodiment.

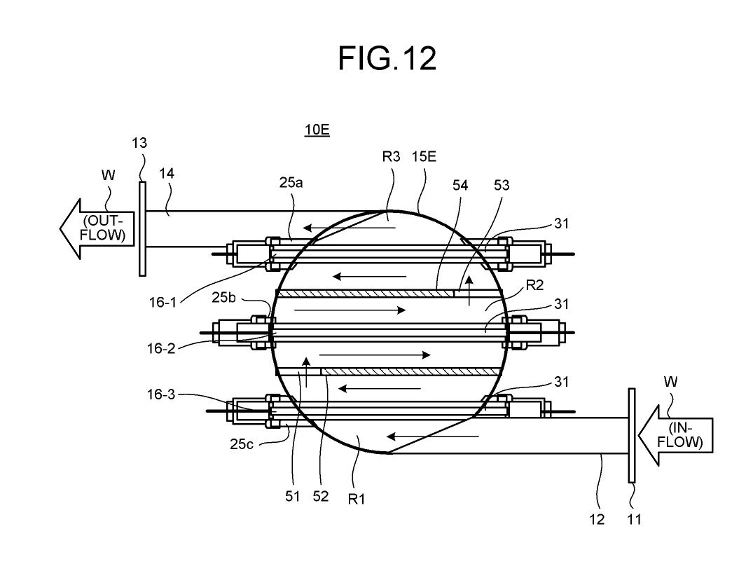

FIG. 12 is a cross sectional view of FIG. 11 along the line indicated by the arrows A-A.

As illustrated in FIGS. 11 and 12, an annular barrel 15E of an ultraviolet irradiation device 10E is sectioned into three rooms R1 to R3 by a first partition board 52 having an opening 51 and a second partition board 54 having an opening 53. An ultraviolet irradiation tube 16-3 is placed in the room R1, an ultraviolet irradiation tube 16-2 is placed in the room R2, and an ultraviolet irradiation tube 16-1 is placed in the room R3.

Here, the openings 51 and 53 are located such that water to be treated W flows zigzag inside the annular barrel 15E.

As a result, the water to be treated W flows into the annular barrel 15E through an inflow pipe 12, flows around all the ultraviolet irradiation tubes 16-1 to 16-3 along the extension of an ultraviolet lamp 31, and flows out from an outflow pipe 14.

Therefore, according to the sixth embodiment, the water to be treated W flows along the extension of the ultraviolet lamp 31 so that it is uniformly irradiated with ultraviolet light emitted from the ultraviolet lamp 31. The ultraviolet light can thus contribute to the sterilizing (disinfecting) treatment or oxidation treatment of target substances such as microorganisms, organic matter and inorganic matter contained in the water to be treated W.

### [7] Effect of Embodiments

According to each embodiment described above, all of the water to be treated W surely flows in a spiral or zigzag in the vicinity of the ultraviolet lamp 31 and is uniformly irradiated with the ultraviolet light emitted from the ultraviolet lamp 31. Thus, the ultraviolet light can contribute to the sterilizing (disinfecting) treatment or oxidation treatment of target substances such as microorganisms, organic matter and inorganic matter contained in the water to be treated W.

While several embodiments of the present invention have been described, these embodiments have been illustrated by way of example and are not intended to limit the scope of the invention. These novel embodiments can be implemented in various other modes and be subjected to various omissions, substitutions and modifications without departing from the gist of the invention. These embodiments and variations thereof are included in the scope and gist of the invention as well as in the inventions described in claims and its equivalents.

What is claimed is:

1. An ultraviolet irradiation device comprising:
a barrel in which an ultraviolet irradiation tube is placed, the ultraviolet irradiation tube irradiating an inflow of water to be treated with ultraviolet light;
an inflow pipe through which the water to be treated flows into the barrel; and
an outflow pipe through which the water to be treated flows out of the barrel, wherein
the inflow pipe and the outflow pipe are arranged to allow the water to be treated to form into a swirl flowing along an inner wall of the barrel.

2. The ultraviolet irradiation device according to claim 1, wherein
the barrel includes an annular barrel having a circular cross section and a columnar shape, and
the inflow pipe and the outflow pipe are aligned along a tangent line to the circle.

3. The ultraviolet irradiation device according to claim 2, wherein
the inflow pipe and the outflow pipe are arranged at a certain distance away from each other in a height direction of the column.

4. The ultraviolet irradiation device according to claim 2, wherein
an inflow direction of the water to be treated into the inflow pipe and an outflow direction of the water to be treated through the outflow pipe are parallel and opposite to each other.

5. The ultraviolet irradiation device according to claim 2, wherein
An inflow direction of the water to be treated into the inflow pipe and an outflow direction of the water to be treated through the outflow pipe are parallel to each other and a same direction.

6. The ultraviolet irradiation device according to claim 2, wherein
a plurality of the ultraviolet irradiation tubes are arranged on a virtual plane perpendicular to the height direction of the column or on a virtual plane tilted by a certain angle with respect to the virtual perpendicular plane.

7. The ultraviolet irradiation device according to claim 6, wherein
the plurality of ultraviolet irradiation tubes is arranged in parallel to one another on a same virtual plane.

8. The ultraviolet irradiation device according to claim 6, wherein
the plurality of ultraviolet irradiation tubes are arranged in parallel to one another on each of a plurality of virtual planes, the virtual planes being arranged parallel to one another at a certain distance away from another virtual plane.

9. The ultraviolet irradiation device according to claim 8, wherein
the ultraviolet irradiation tubes are arranged on the plurality of virtual planes to intersect one another, when viewed from the height direction.

10. The ultraviolet irradiation device according to claim 1, wherein
the barrel includes an annular barrel and a truncated-cone barrel that are connected continuously, the annular barrel having a circular cross section and a columnar shape, the truncated-cone barrel having a truncated cone shape,
the inflow pipe is aligned along a tangent line to the circle, and
the outflow pipe is placed at a tip of a small diameter of the truncated cone.

11. An ultraviolet irradiation device comprising:
a barrel in which a straight ultraviolet irradiation tube is placed, the ultraviolet irradiation tube irradiating ultraviolet light to an inflow of water to be treated;
an inflow pipe through which the water to be treated flows into the barrel; and
an outflow pipe through which the water to be treated flows out of the barrel, wherein
a zigzag passage is configured within the barrel by a partition board, and
the ultraviolet irradiation tube is aligned in a flowing direction of the water to be treated in the passage.
